(19) United States
(12) Patent Application Publication
(10) Pub. No.: US 2018/0343493 A1
(43) Pub. Date: Nov. 29, 2018

(54) TOUCH ELECTRONIC WHITEBOARD WITH AUTOMATIC RECOGNITION FOR VIDEO SWITCHING

(71) Applicant: Suzhou Maxpad Technologies Co., Ltd, Jiangsu Province (CN)

(72) Inventors: Ming-Tang TSAI, Taipei City (TW); Huaming WANG, Jiangsu Province (CN)

(21) Appl. No.: 15/870,895

(22) Filed: Jan. 13, 2018

(30) Foreign Application Priority Data
May 26, 2017 (CN) 201720603831.7

(51) Int. Cl. H04N 21/4363; G06F 3/042; H04N 7/15; H04N 21/61; H04N 21/4415

(52) U.S. Cl. CPC H04N 21/43635; G06F 3/0425; H04N 21/4415; H04N 21/6118; H04N 7/15

(57) ABSTRACT

The present invention discloses a touch electronic whiteboard with automatic recognition for video switching. A computer host is built in an electronic whiteboard body. A HUB integrator is disposed on a frame of the electronic whiteboard body. A projector is disposed above the electronic whiteboard body. A video switching control module is built in the frame of the electronic whiteboard body. The video switching control module comprises a level detection circuit and a control chip that are connected to each other. The level detection circuit is connected to the HUB integrator. The control chip is separately connected to the projector and the computer host.

### FIELD OF THE INVENTION

The present invention relates to an electronic whiteboard, and in particular, to a touch electronic whiteboard with automatic recognition for video switching.

### BACKGROUND OF THE INVENTION

The Chinese utility model patent of publication No. CN205210853U published on May 4, 2016 discloses an interactive electronic whiteboard with a built-in computer, comprising an electronic whiteboard body. A control mainboard is built in a frame of the electronic whiteboard body. A projector is disposed on the electronic whiteboard body. A computer host is built in the electronic whiteboard body. The computer host is connected to the projector. The projector is connected to the control mainboard. A high-speed document scanner is further disposed on the electronic whiteboard body, and the high-speed document scanner is connected to the computer host. When an external device (a notebook computer or the like) is connected to a USB HUB multi-interface sharing device, whether the external device is allowed to connect to the projector needs to be determined manually. If the connection is allowed, the computer host is disconnected from the control mainboard, and the external device is directly connected to the projector. The selection process is miscellaneous, affecting user experience of the electronic whiteboard.

### SUMMARY OF THE INVENTION

To overcome the foregoing disadvantage, the objective of the present invention is to provide a touch electronic whiteboard with automatic recognition for video switching, which can automatically recognize a connection of an external device, and directly connect the external device to a projector.

To achieve the foregoing objective, a technical solution used in the present invention is a touch electronic whiteboard with automatic recognition for video switching, comprising an electronic whiteboard body. A computer host is built in the electronic whiteboard body. A HUB integrator is disposed on a frame of the electronic whiteboard body. A projector is disposed above the electronic whiteboard body. A video switching control module is built in the frame of the electronic whiteboard body. The video switching control module comprises a level detection circuit and a control chip that are connected to each other. The level detection circuit is connected to the HUB integrator. The control chip is separately connected to the projector and the computer host. Video switching between the built-in computer host and an external access device is performed by using the video switching control module. When the external access device accesses the electronic whiteboard, the computer host is automatically disconnected from the electronic whiteboard, to display a video of the external access device.

Preferably, to increase a transmission speed of the electronic whiteboard for high-quality video transmission, the video switching control module is separately connected to the HUB integrator, the projector, and the computer host by using an HDMI cable. In this way, projection is implemented quickly after access of the external access device, thereby improving user experience of the electronic whiteboard.

In a further improvement of the present invention, the electronic whiteboard further comprises a camera. The camera is disposed in an upper frame of the frame of the electronic whiteboard body. The camera is formed by an optical lens, an optical sensor, and a camera control mainboard that are sequentially connected. The optical sensor is connected to the computer host by using the camera control mainboard. The camera is disposed to enable persons in two conference rooms to perform a video communication function. The optical lens captures an image. The optical sensor is configured to convert a captured image signal into a data signal, and then transmit, by using the camera control mainboard, the data signal to a first computer host connected to the electronic whiteboard. The first computer host then transmits the image data through a network to a second computer host connected to another electronic whiteboard, to perform the intuitive video communication function on the two electronic whiteboards.

In a further improvement of the present invention, the electronic whiteboard body is an infrared touch electronic board. The touch electronic whiteboard comprises at least two infrared cameras and an optical reflection strip. The at least two infrared cameras are disposed on the frame of the electronic whiteboard body. The optical reflection strip is disposed on four sides of the frame of the electronic whiteboard body. Each infrared camera has an LED light source inside, and the LED light source is capable of emitting light to the optical reflection strip opposite. The infrared camera in which the LED light source is built receives reflected light. Two adjacent infrared cameras transmit detected signals to the control chip. The control chip calculates data of a touch point on the optical reflection strip, to obtain touch coordinates.

In a further improvement of the present invention, the electronic whiteboard body has a layered structure, comprising a bottom layer, an intermediate layer, and a surface layer. The surface layer is coated with an anti-reflective layer, and the intermediate layer is in an aluminum honeycomb structure. The anti-reflective layer can ensure that a user can clearly see content at any angle. An aluminum honeycomb plate can ensure the flatness of the electronic whiteboard body, so that signal receiving of the infrared cameras is not affected.

In a further improvement of the present invention, the electronic whiteboard further comprises a fingerprint recognition lock. The fingerprint recognition lock is connected to the control chip. An identification function is added, which facilitates management and control of the user.

In a further improvement of the present invention, an audio expander is built in the frame of the electronic whiteboard body, and the audio expander is formed by at least two audio output speakers, thereby implementing audio sharing.

Preferably, the projector is an ultra short-focus projector. A problem of a projection failure caused as an object blocks projected light can be resolved.

Preferably, the surface and corners of the frame of the electronic whiteboard body are of a smooth curved surface, which effectively protects children from scratches or bruises, and reduces safety threats.

### BRIEF DESCRIPTION OF THE DRAWINGS

FIG. 1 is a schematic main view according to the present invention;

FIG. 2 is a side view with a partial cutaway according to the present invention; and

FIG. 3 is a schematic diagram of a video switching control module according to the present invention.

In the Figures: 1: Camera; 2: Video switching control module; 21: Level detection circuit; 22: Control chip; 3: Infrared camera; 4: Speaker; 5: HUB integrator; 6: Fingerprint recognition lock; 7: Electronic whiteboard body; 71: Surface layer; 72: Intermediate layer; 73: Bottom layer; 74: Frame; 8: Optical reflection strip; 9: Projector; 10: High-speed document scanner; 11: Computer host; and 12: Camera control mainboard.

### DETAILED DESCRIPTION OF THE INVENTION

To enable persons skilled in the art to more easily understand the advantages and features of the present invention, the following provides a detailed description with reference to the accompanying drawings by using preferred embodiments of the present invention, to define the protection scope of the present invention clearer.

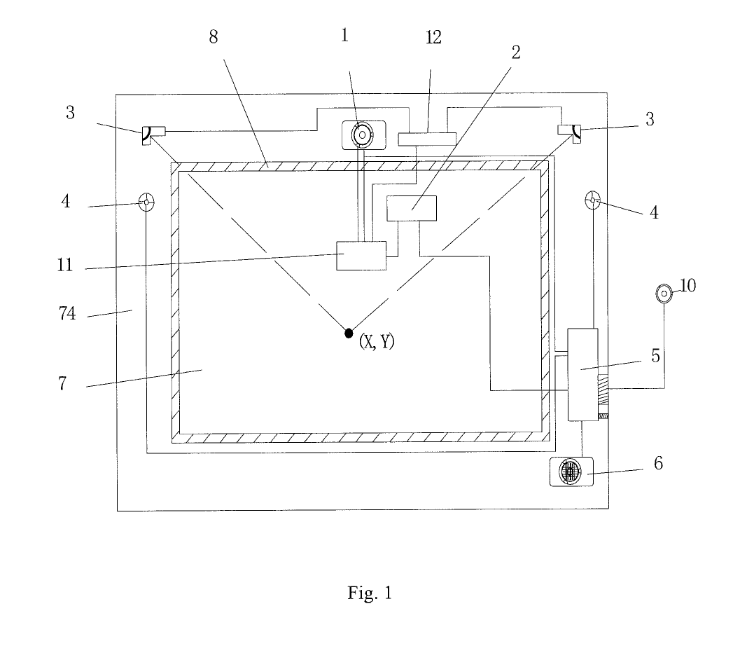

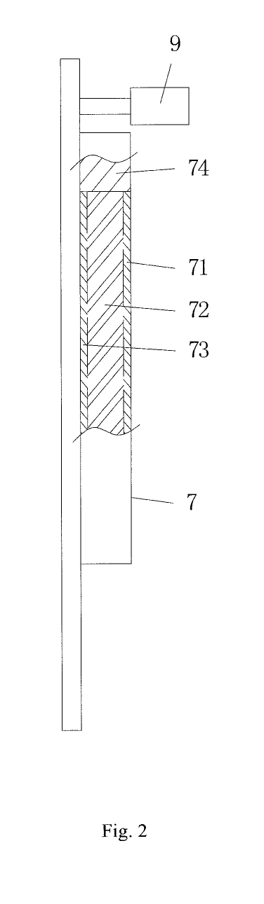

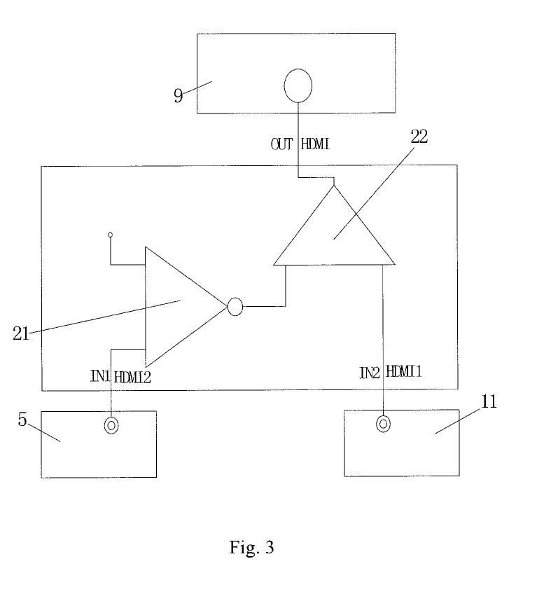

Referring to FIGS. 1, 2, and 3, a touch electronic whiteboard with automatic recognition for video switching in an embodiment comprises an electronic whiteboard body 7. A computer host 11 is built in the electronic whiteboard body 7. A HUB integrator 5 is disposed on a frame 74 of the electronic whiteboard body 7. A projector 9 is disposed above the electronic whiteboard body 7. A video switching control module 2 is built in the frame 74 of the electronic whiteboard body 7. The video switching control module 2 comprises a level detection circuit 21 and a control chip 22 that are connected to each other. The level detection circuit 21 is connected to the HUB integrator 22. The control chip 22 is separately connected to the projector 9 and the computer host 11.

The level detection circuit in this embodiment belongs to the prior art, and is a level detector that can eliminate dependency on power supply voltage fluctuation and device tolerance and that runs at a high speed with a low voltage. The level detection circuit performs, by using a resistance-type divided voltage, a pre-determined level change from a signal voltage level that is input by a load voltage generation circuit. The divided voltage is obtained by a voltage divider resistor element by using a reference power supply voltage independent of a power supply voltage provided to the circuit. An output of a difference between a level change signal that is output by a differential amplifier feed level changer and a pre-determined reference voltage is used as a detection output. Because the reference power supply voltage is independent of the power supply voltage, power supply voltage fluctuation can be limited for stable operations.

To increase a transmission speed of the electronic whiteboard for high-quality video transmission, the video switching control module is separately connected to the HUB integrator, the projector, and the computer host by using an HDMI cable. In this way, projection is implemented quickly after access of an external access device, thereby improving user experience of the electronic whiteboard. The used HDMI cable is short for a high-definition multimedia interface cable, and can transmit, with high quality, uncompressed high-definition videos and multi-channel audio data, with a highest data transmission speed of 5 Gbps. In addition, digital-to-analog or analog-to-digital conversion does not need to be performed before signal transmission, and highest-quality audio and video signal transmission can be ensured.

When an external device product is inserted into an HDMI 1 interface on the HUB integrator, IN1 of the video switching control module is at a low level, and the electronic whiteboard automatically preferentially selects a video signal that is output by the external device product. When the external electronic product is removed, the electronic whiteboard automatically switches back to an output of a video signal of IN2 of the built-in computer host. In this way, automatic switching can be implemented without manual operations, and operations are simple and convenient. This can be widely applied to various electronic whiteboards, integrated machines, and the like.

In this embodiment, a high-speed document scanner 10 is further disposed on the electronic whiteboard body 7, and the high-speed document scanner 10 is connected to the computer host 11. The high-speed document scanner is configured to perform functions of scanning, photographing, and recording files, pictures, and objects, and transmit them to the computer host 11 for storage, implementing electronic reading and recognition. To resolve a problem of a projection failure caused as an object blocks projected light, the projector 9 is an ultra short-focus projector.

To implement image transmission and video communication functions, the touch electronic whiteboard with automatic recognition for video switching further comprises a camera 1. The camera 1 is disposed in an upper frame of the frame 74 of the electronic whiteboard body 7. The camera 1 is formed by an optical lens configured to capture an image, an optical sensor configured to convert the image into a data signal, and a camera control mainboard 12 configured to transmit the data signal to the computer host 11 that are sequentially connected. The optical lens and the optical sensor are configured to record a live conference video and transmit the video to the computer host 11 by using the camera control mainboard 12. The computer host 11 is connected to another computer host 11 by using a network. The video is displayed on an electronic whiteboard body connected to the another computer host 11, thereby implementing the image transmission and video communication functions.

The electronic whiteboard body 7 can implement a touch control function because the electronic whiteboard body 7 is an infrared touch electronic board. The infrared touch electronic board comprises at least two infrared cameras 3 and an optical reflection strip 8. The at least two infrared cameras 3 are disposed on the frame 74 of the electronic whiteboard body 7. FIG. 1 shows two infrared cameras 3, and certainly, four corners of the frame 74 may be each provided with an infrared camera 3. The optical reflection strip 8 is disposed on four sides of the frame 74 of the electronic whiteboard body 7. Each infrared camera 3 has an LED light source (not shown in the figure) inside, and the LED light source is capable of emitting light to the optical reflection strip 8 opposite. The infrared camera 3 in which the LED light source is built receives reflected light. If there is no object operating on the electronic whiteboard body 7, the infrared camera 3 receives the reflected light of the optical reflection strip 8. Once there is an object operating on the electronic whiteboard body 7, the light of the LED light source cannot reach the optical reflection strip 8, and the infrared camera 3 cannot detect the reflected light. According to the principle, two infrared cameras 3 transmit detected signals to the video switching control module 2. The video switching control module 2 calculates data of a touch point on the optical reflection strip 8, to obtain touch coordinates (X, Y). When four infrared cameras 3 are disposed, touch control of at least two points can be implemented at the same time.

The electronic whiteboard body 7 can implement audio sharing because an audio expander is built in the frame 74 of the electronic whiteboard body 7. The audio expander is formed by at least two audio output speakers 4. As shown in FIG. 1, two audio output speakers 4 are disposed, and located on two sides of the electronic whiteboard body 7.

A fingerprint recognition lock 6 is disposed on the electronic whiteboard body 7, and the fingerprint recognition lock 6 is connected to the control chip 22. An identification function is added, which facilitates management and control of the user.

The electronic whiteboard body 7 has a layered structure, comprising: a bottom layer 73, an intermediate layer 72, and a surface layer 71. When an electronic function is not used, the electronic whiteboard functions as an ordinary whiteboard, on which writing may be performed on the surface of the surface layer 71 by using a greasy pen or pens of other materials. The surface layer 71 is a high matt enamel coating layer, which is a type of inorganic glass, and is attached to a metal surface by means of high-temperature fusion, to ensure that content on the electronic whiteboard body 7 can be clearly seen at multiple angles. The coating layer is firm, can protect the electronic whiteboard from being scratched from a hard object, and has a service life up to 20 years. Writing on the coating layer is easy to wipe and leaves no traces. Use convenience is greatly improved. The intermediate layer 72 is an aluminum honeycomb plate. Because the bottom layer 73 and the surface layer 71 are thin, the intermediate layer 72 uses an aluminum honeycomb structure, so that the flatness of the surface layer 71 is ensured, and touch control is not affected.

The surface and corners of the frame 74 of the electronic whiteboard body 7 are of a smooth curved surface, which effectively protects children from scratches or bruises, and reduces safety threats.

The aforementioned implementations are merely to explain the technical ideas and features of the present invention, intended to help persons skilled in the art to understand and implement the present invention, and not intended to limit the protection scope of the present invention. Various equivalent variations or modifications made without departing from the spirit and essence of the present invention shall fall within the protection scope of the present invention.

1. A touch electronic whiteboard with automatic recognition for video switching, comprising an electronic whiteboard body (7), wherein a computer host (11) is built in the electronic whiteboard body (7), a HUB integrator (5) is disposed on a frame (74) of the electronic whiteboard body (7), and a projector (9) is disposed above the electronic whiteboard body (7), wherein: a video switching control module (2) is built in the frame (74) of the electronic whiteboard body (7), the video switching control module (2) comprises a level detection circuit (21) and a control chip (22) that are connected to each other, the level detection circuit (21) is connected to the HUB integrator (5), and the control chip (22) is separately connected to the projector (9) and the computer host (11).

2. The touch electronic whiteboard with automatic recognition for video switching according to claim 1, wherein: the video switching control module (2) is separately connected to the HUB integrator (5), the projector (9), and the computer host (11) by sing an HDMI cable.

3. The touch electronic whiteboard with automatic recognition for video switching according to claim 2, further comprising a camera (1), wherein the camera (1) is disposed in an upper frame of the frame (74) of the electronic whiteboard body (7), the camera (1) is formed by an optical lens, an optical sensor, and a camera control mainboard (12) that are sequentially connected, and the optical sensor is connected to the computer host (11) by using the camera control mainboard (12).

4. The touch electronic whiteboard with automatic recognition for video switching according to claim 2, wherein: the electronic whiteboard body (7) is an infrared touch electronic board, the touch electronic whiteboard comprises at least two infrared cameras (3) and an optical reflection strip (8), the at least two infrared cameras (3) are disposed on the frame (74) of the electronic whiteboard body (7), the optical reflection strip (8) is disposed on four sides of the frame (74) of the electronic whiteboard body (7), each infrared camera (3) has an LED light source inside, the LED light source is capable of emitting light to the optical reflection strip (8) opposite, the infrared camera (3) in which the LED light source is built receives reflected light, two adjacent infrared cameras (3) transmit detected signals to the control chip (22), and the control chip (22) calculates data of a touch point on the optical reflection strip (8), to obtain touch coordinates.

5. The touch electronic whiteboard with automatic recognition for video switching according to claim 2, wherein: the electronic whiteboard body (7) has a layered structure, comprising: a bottom layer (73), an intermediate layer (72), and a surface layer (71), wherein the surface layer (71) is coated with an anti-reflective layer, and the intermediate layer (72) is in an aluminum honeycomb structure.

6. The touch electronic whiteboard with automatic recognition for video switching according to claim 2, further comprising a fingerprint recognition lock (6), wherein the fingerprint recognition lock (6) is connected to the control chip (22).

7. The touch electronic whiteboard with automatic recognition for video switching according to claim 2, wherein: an audio expander is built in the frame of the electronic whiteboard body (7), and the audio expander is formed by at least two audio output speakers (4).

8. The touch electronic whiteboard with automatic recognition for video switching according to claim 2, wherein: the projector (9) is an ultra short-focus projector.

9. The touch electronic whiteboard with automatic recognition for video switching according to claim 2, wherein: the surface and corners of the frame (74) of the electronic whiteboard body (7) are of a smooth curved surface.
